(19) United States
(12) Patent Application Publication
(10) Pub. No.: US 2019/0213664 A1
(43) Pub. Date: Jul. 11, 2019

(54) STAR-FOLLOWING PRODUCT SALES SYSTEM AND METHOD THEREFOR

(71) Applicant: Ki-won Nam, Seoul (KR)

(72) Inventor: Ki-won Nam, Seoul (KR)

(21) Appl. No.: 16/096,823

(22) PCT Filed: Apr. 28, 2017
(86) PCT No.: PCT/KR2017/004558

§ 371 Date: Mar. 19, 2019

(30) Foreign Application Priority Data
Apr. 28, 2016 (KR) 10-2016-0052499

(51) Int. Cl. G06Q 30/06; G06Q 30/02

(52) U.S. Cl. CPC G06Q 30/0641; G06Q 30/0603; G06Q 30/0214; G06Q 30/0246

(57) ABSTRACT

The present invention relates to a star-following product sale system and a method thereof, and more particularly, to a star-following product sale system and a method thereof, in which a part of profits obtained from star-following users who perform star-following browsing or a star-following purchase of products at the time of payment of the star is fed back thereto, thus to determine a payment limit of the star, and the star may execute a payment within the payment limit, thereby providing a cycle of star-driven positive reinforcement. By applying the present invention, when browsing product information or purchasing and making a payment of a product by a user who follows the star to perform star-following browsing or a star-following purchase through the system, the payment limit of the star may be increased and a limit of an amount on the selection of the star may be removed by the above star-following browsing or star-following purchase action. Therefore, it is possible to give more freedom to the star in the selection of products, and provide useful product information to star-following purchasers, such that a cycle of star-driven positive reinforcement can be formed therebetween.

### TECHNICAL FIELD

The present invention relates to a star-following product sale system and a method thereof, and more particularly, to a star-following product sale system and a method thereof, in which a part of profits obtained from star-following users who perform star-following browsing or a star-following purchase of products at the time of payment of the star is fed back thereto, thus to determine a payment limit of the star, and the star may execute a payment within the payment limit, thereby providing a cycle of star-driven positive reinforcement.

### BACKGROUND ART

As well known in the art, in accordance with recent development of information communication technology, a technology for information service that provides information on various fields by wide area data communication network in real time to multiple subscribers through at least one host server has been actively developed.

Based on the technology, recently, a peripheral technology such as a cache memory expansion technology for more rapidly providing accurate information to a subscriber, and an information sorting and compression technology for more conveniently accessing taste and preference of the subscriber have been developed. Accordingly, development of various contents and solutions therethrough is also accelerated.

People, such as entertainers, actors, famous athletes, singers, and broadcasters, who are familiar faces and names to the public, are referred to as a star.

Basically, the star is a person who provides a good image to the public, and in particular, has power of influence since he or she is an idol for enthusiastic fans.

Moreover, because the star creates or sets trends, marketing of products using the star (‘star marketing’) may be very effective in a case of promoting new products.

Therefore, a seller who sells the product tries to promote sales through the star marketing. However, when selecting a star as a pictorial model for star marketing and assigning the star to work, costs are excessive. As a result, it is almost impossible for general small and medium enterprises to use the star marketing.

The stars are persons who are similar to ordinary people in real life, or who wear clothes that are slightly more specific and unique than ordinary people, even though they have an image to wear expensive luxury products. Most of the household items, including clothing, clothing products and accessories, which the stars wear in their daily life, are bought by the star directly paying their own money.

In addition, fans have a culture of delivering various gifts to the star. However, the gifts sent by the fans may be items that the star already owns, or it may not suit the taste of the star.

In other words, since there is no system of star-driven promotion and consumption cycle structure in the art, it is not possible to obtain synergy effects between the fan and a general person who is not the fan of a specific star but is interested in a style of the clothing or accessories worn by the star, as well as the stars and the sellers.

### SUMMARY OF INVENTION

### Problems to be Solved by Invention

In consideration of the above-mentioned circumstances, it is an object of the present invention to provide a star-following product sale system and a method thereof, in which a part of profits obtained from star-following users who perform star-following browsing or a star-following purchase of products at the time of payment of the star is fed back thereto, thus to determine a payment limit of the star, and the star may execute a payment within the payment limit, thereby providing a cycle of star-driven positive reinforcement.

### Means for Solving Problems

To achieve the above object, according to an aspect of the present invention, there is provided a star-following product sale system including: a star terminal 2 provided with a star exclusive product purchase application 4 configured to receive product information and payment limit information for each product from a star-following product sale server 20; a star-following user terminal 6 provided with a star-following purchase application 8 configured to set a specific star who is a target of star-following browsing or star-following purchase in the star-following product sale server 20, receive and browse information of a product purchased by the specific star from the star-following product sale server 20, and generate a purchase signal for the product; a sale server 10 configured to register the product information and star designation information in the star-following product sale server 20; and the star-following product sale server 20 configured to register the product information for each star designated by a seller so as to purchase the product by the star, register information of a user who desires to perform the star-following browsing or star-following purchase of each star, calculate payment limits of each star to provide to the stars, and update the payment limits based on profits generated for a star-following user due to the purchase of the stars.

Preferably, the star-following product sale server 20 includes an automatic purchase setting unit 32 configured to set automatic purchase of information on a specific product purchased by the specific star; and a product search unit 34 configured to search for the specific product among the products registered in the sale server.

Preferably, the star-following product sale server 20 further includes an advertisement cost per click (CPC) information registration unit 42 configured to register information of an advertisement cost per click provided upon browsing the product information.

Preferably, the star-following product sale server 20 further includes a star-following browsing/purchase setting unit 28 configured to register information of the star-following user including designation information on a specific star desired to follow, desired category information on a star-following product, and desired amount range information on the star-following product.

Preferably, the star-following product sale server 20 provides an electronic payment means such as Star Pay to the star exclusive product purchase application 4 so as to use payment limit amounts assigned for each star in purchasing the products, and performs the payment by communication therebetween.

Preferably, the system further includes a financial server 12 configured to assign accounts for each star in conjunction with the star-following product sale server 20, and make a payment for the product by an amount transferred or payment limit assigned to the accounts from the star-following product sale server 20.

Preferably, the star-following product sale server 20 further includes a product information sort unit 30 configured to sort the registered products according to a specific sort condition selected by the star.

Preferably, the star-following product sale server 20 further includes a star payment limit calculation unit 44 configured to calculate a payment limit of the star so that an amount, which is obtained by multiplying an advertisement cost per click (CPC) for each product with being classified into each star by the number of users set to perform star-following browsing, is included in the payment limit amount for each product of the star upon calculation.

Preferably, the star-following product sale server 20 further includes a star payment limit calculation unit 44 configured to calculate a payment limit so that an amount, which is obtained by multiplying a star sale promotion amount classified into each star and assigned for each product by the number of users set to perform an automatic star-following purchase, is included in the payment limit amount for each product of the star upon calculation.

Preferably, the star-following product sale server 20 further includes a star payment limit calculation unit 44 configured to calculate a payment limit so that an amount, which is obtained by multiplying an estimated sale rate for each star based on a purchase rate among the total number of browsing users by the number of users set to perform star-following browsing, is included in the payment limit amount for each product of the star upon calculation.

Preferably, the star-following product sale server 20 transmits electronic payment means information including an image of a star predesignated by the star-following user to the star-following user terminal 6 at the time of star-following browsing or receiving a star-following purchase signal.

Preferably, the star-following product sale server 20 further includes: a communication module 22 configured to communicate with the applications and the servers; a product registration unit 24 configured to register information of products to be sold; a product registration unit 36 for each star configured to classify and register the information of the products to be sold as a sub-category of a specific star so that the specific star can browse or purchase the products to be sold; a star information registration unit 26 configured to register information of a star who purchases the products registered in the product registration unit 24 and desires to receive a payment limit amount provided upon purchase of the product; and a controller 50 configured to control the registration units so as to provide a part of the profits generated based on the browsing of information on star-following products for each specific star or star-following purchase as payment limit amounts for each product of the specific star, thereby inducing the star-following browsing or purchase of the products.

Preferably, the star-following product sale server 20 further includes: a payment information management unit 38 configured to manage payment information of the star and star-following user; and a star-following information processer 40 configured to extract information of a star-following user who designates a star when purchasing a product by the star, and transmit information of the product purchased by the star or perform automatic purchase of the product.

Preferably, the star-following product sale server 20 further includes a payment limit calculation unit 48 for each product configured to, when clicking a plurality of pieces of product information registered to be purchased by the specific star, manage a payment limit for each product, which is calculated based on the number of the star-following users for the star, a category, an amount range and a promotion rate of the products, so as to be transmitted by a request of the star.

Preferably, the star-following product sale server 20 further includes a follow-up star image registration unit 46 configured to register an image of a star predesignated by the star-following user so as to transmit product information to the star-following user terminal 6 at the time of browsing the product information or purchasing the product through the star-following user terminal 6.

Preferably, the star-following product sale server sorts the registered products according to a specific sort condition including sequential orders of a concept or a category to which the product pertains, a promotion amount of the product, a promotion rate for a sale price of the product.

According to another aspect the present invention, there is provided a star-following product sale method including: a) receiving, by a star-following product sale server 20, a selection signal for a specific product from the star terminal 2; b) transmitting, by the star-following product sale server 20, payment limit amount information for the specific product of a star; c) receiving, by the star-following product sale server 20, a purchase signal for the specific product from the star terminal 2; d) making, by the star-following product sale server 20, a payment of a product purchased by the star; e) transmitting, by the star-following product sale server 20, information of the product to a user who preregisters star-following browsing of the product purchased by the star; f) receiving, by the star-following product sale server 20, a purchase signal for the product from a star-following user terminal 6; g) calculating, by the star-following product sale server 20, a payment limit amount for the product of the star; and h) updating, by the star-following product sale server 20, the payment limit amount for the product of the star.

Preferably, the method further includes: before the step a), receiving and registering, by the star-following product sale server 20, designation information of a specific star and product information, and amount information from a seller, and amount information to be promoted to the star for the product at the time of purchasing the product by a star-following user.

Preferably, the method further includes: before the step a), receiving and registering, by the star-following product sale server 20, set information of a specific star who is a target of star-following browsing or star-following purchase from the star-following user terminal 6.

Preferably, the method further includes: before the step a), extracting, by the star-following product sale server 20, information of the product matched to the star, and transmitting the extracted product information to the star terminal 2.

Preferably, the method further includes: before the step a), receiving and registering, by the star-following product sale server 20, information of a star-following user including designation information on a specific star desired to follow, desired category information on a star-following product, and desired amount range information on the star-following product from the star-following user terminal 6.

Preferably, the method further includes: before the step a), transmitting, by the star-following product sale server 20, information of products predesignated by a star-following user to the star terminal 2.

Preferably, the method further includes: before the step a), sorting, by the star-following product sale server 20, the registered products according to a specific sort condition selected by the star.

Preferably, the step g) includes calculating, by the star-following product sale server 20, a payment limit of the star so that an amount, which is obtained by multiplying an advertisement cost per click (CPC) for each product with being classified into each star by the number of users set to perform star-following browsing, is included in the payment limit amount for each product of the star upon calculation.

Preferably, the step g) includes calculating, by the star-following product sale server 20, a payment limit so that an amount, which is obtained by multiplying a star sale promotion amount classified into each star and assigned for each product by the number of users set to perform an automatic star-following purchase, is included in the payment limit amount for each product of the star upon calculation.

Preferably, the step g) includes calculating, by the star-following product sale server 20, a payment limit so that an amount, which is obtained by multiplying an estimated sale rate for each star based on a purchase rate among the total number of browsing users by the number of users set to perform star-following browsing, is included in the payment limit amount for each product of the star upon calculation.

Preferably, the method further includes: before the step a), receiving and registering, by the star-following product sale server 20, category information and amount information for a specific product, which are targets for requesting information to perform star-following browsing or a star-following purchase from the star-following user terminal 6.

Preferably, the step e) further includes, if a plurality of stars are registered by the star-following user, transmitting, by the star-following product sale server 20, together with information indicating that the product information is follow-up information of what star, when transmitting the product information which is target information to perform star-following browsing or a star-following purchase to the star-following user terminal 6.

Preferably, the method further includes registering, by the star-following product sale server 20, advertisement cost information per click for each product from a seller.

Preferably, the method further includes receiving and resorting, by the star-following product sale server 20, sort request information on sequential orders of a concept or a category to which the product pertains, a promotion amount of the product, a promotion rate for a sale price of the product from the star terminal 2.

### Advantageous Effects

According to the star-following product sale system and method of the present invention, when browsing product information or purchasing and making a payment of a product by a user who follows the star to perform star-following browsing or a star-following purchase through the system, the payment limit of the star may be increased and a limit of an amount on the selection of the star may be removed by the above star-following browsing or star-following purchase action. Therefore, it is possible to give more freedom to the star in the selection of products, and provide useful product information to star-following purchasers, as well as the sellers may achieve both star marketing and mass sales, such that a cycle of star-driven positive reinforcement can be formed therebetween.

### BRIEF DESCRIPTION OF DRAWINGS

FIG. 1 is a block diagram illustrating a schematic configuration of a star-following product sale system according to an embodiment of the present invention.

FIG. 2 is a flowchart illustrating a data flow of star-following browsing and star-following purchase in the star-following product sale system according to the embodiment of the present invention.

FIG. 3 is a block diagram illustrating a configuration of a star-following product sale server included in the star-following product sale system according to the embodiment of the present invention.

FIG. 4 is a diagram illustrating product sort information output to a star through the star-following product sale system according to the embodiment of the present invention.

FIG. 5 is a diagram for explaining setting and information transmission principles for the star-following browsing and star-following purchase through the star-following product sale system according to the embodiment of the present invention.

FIG. 6 is a diagram illustrating a state of setting to follow a plurality of stars through the star-following product sale system according to the embodiment of the present invention.

FIG. 7 is a block diagram illustrating a state of calculating a payment limit of the star through the star-following product sale system according to the embodiment of the present invention.

### MODE FOR CARRYING OUT INVENTION

Hereinafter, the present invention will be described in detail with reference to the accompanying drawings.

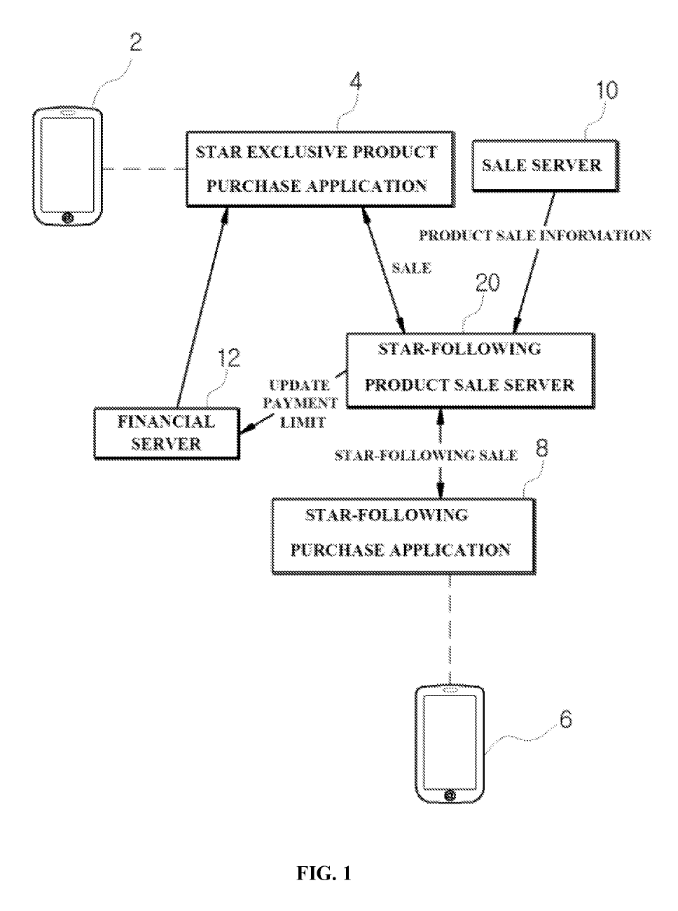

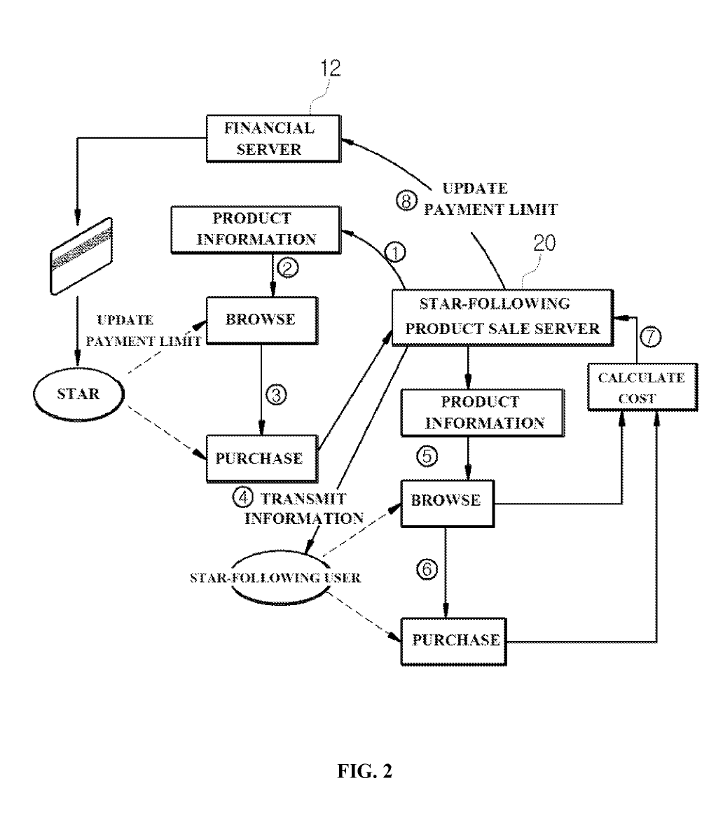

FIG. 1 is a block diagram illustrating a schematic configuration of a star-following product sale system according to an embodiment of the present invention, and FIG. 2 is a flowchart illustrating a data flow of star-following browsing and star-following purchase in the star-following product sale system according to the embodiment of the present invention.

Referring to FIGS. 1 and 2, the system is a system in which a part of profits obtained from star-following users who perform star-following browsing or a star-following purchase of products at the time of payment of the star is fed back thereto, thus to determine a payment limit of the star, and the star may execute a payment within the payment limit, thereby providing a cycle of star-driven positive reinforcement.

In other words, when the star-following users designate a star to which the users are to follow, a part of profits obtained from the star-following users who perform star-following browsing of product information or star-following purchase of the product due to a purchase action of the star is predicted and calculated, so as to provide the calculated profit to the star as a payment limit thereof in advance. Therefore, it is possible to form a star-driven promotion and consumption cycle structure between the star, the star-following users and the sellers.

At this time, the star-following product sale system according to the embodiment of the present invention has the same marketing and payment structure as that in not only online sales but also offline sales, which will be described in detail below.

Meanwhile, the payment limit provided to each star through the star-following product sale system according to the embodiment of the present invention may be changed and updated in real time in proportion to the number of the star-following users who perform the star-following browsing and star-following purchase and the profit generated thereby.

At this time, the star-following user may receive information on products to be purchased or set a category and an amount range thereof in advance. Therefore, the payment limit assigned to each star is provided differently from each other for each product that the star wants to purchase.

That is, when a star-following user of 10 years old designates a specific star and the star purchases a product, reception of the product information may be set. When the star-following user designates the category and amount range that the user can purchase and has interest in, and if satisfying conditions of the product, it is possible to set the product information so as to be provided. For example, since the 10-year-old star-following user may not have an economic capacity or interest enough to buy a luxury bag, the category and amount range of the product may be predesignated as a condition set to receive the product information.

More specifically, the star-following product sale system according to the embodiment of the present invention includes: a star terminal 2 provided with a star exclusive product purchase application 4 configured to receive product information and payment limit information for each product from a star-following product sale server 20; and a star-following user terminal 6 provided with a star-following purchase application 8 configured to set a specific star who is a target of star-following browsing or star-following purchase in the star-following product sale server 20, receive and browse information of a product purchased by the specific star from the star-following product sale server 20, and generate a purchase signal for the product.

The star-following product sale system according to the embodiment of the present invention may register various types of product information, provide the product information so as to be browsed, and perform payment processing. Therefore, this system may be provided with an online shopping mall.

In addition, the star terminal 2 has the star exclusive product purchase application 4 installed therein. The star exclusive product purchase application 4 communicates with the star-following product sale server 20 to transmit and receive various data.

In other words, when the star drives the star exclusive product purchase application 4 to browse a plurality of pieces of product information provided by the star-following product sale server 20, and if the product information is browsed by the star, the star receives his/her payment limit from the star-following product sale server 20. Thereby, the star can confirm whether he/she can pay for the product or pay only a part of the payment amount of the product, and generate a purchase signal for the product to the star-following product sale server 20.

Meanwhile, the star-following user terminal 6 also has the star-following purchase application 8 installed therein. The star-following purchase application 8 communicates with the star-following product sale server 20 to transmit and receive various data.

The star-following user may be a fan who desires to receive information of a product purchased by a specific star or purchase the product by following the star, or a general person who is not the fan but desires to receive information of the product purchased by the specific star or purchase the product because he/she is interested in a style of clothing or accessories worn by the star.

That is, the star-following user is a user who performs star-following browsing on the information of the product purchased by the star or performs a star-following purchase for the product by following the star.

The star-following product sale system according to the embodiment of the present invention further includes: a sale server 10 configured to register the product information and star designation information in the star-following product sale server 20; the star-following product sale server 20 configured to register the product information for each star designated by a seller so as to purchase the product by the star, register information of a user who desires to perform the star-following browsing or star-following purchase of each star, calculate payment limits of each star to provide to the stars, and update the payment limits based on profits generated for a star-following user due to the purchase of the stars; and a financial server 12 configured to assign accounts for each star in conjunction with the star-following product sale server 20, and make a payment for the product by an amount transferred or payment limit assigned to the accounts from the star-following product sale server 20.

The sale server 10 is a server operated by the seller, but may be replaced with a seller terminal. The sellers may set a star so that their product can be sold through the star-following purchase of the star-following user for a specific star. When setting the specific star by the seller, information of the product may be exposed only to the star set by the seller.

That is, in the star-following product sale system according to the embodiment of the present invention, the seller and the star-following user may set a specific star, and the star may select a product to be purchased and perform the payment within the received payment limit. If the star has an inexperienced eye for products, the number of star-following users will inevitably be reduced even if he/she is an A-list star. As a result, the payment limit of the star is also reduced.

At this time, the star-following product sale system according to the embodiment of the present invention may include various payment means at the time of payment of the star. The payment means may include all payment means such as a credit card, a check card, an online payment, a coupon or the like.

Since the star-following product sale system according to the embodiment of the present invention needs to assign the payment limit through the star-following product sale server 20, and the payment limit needs to be applied to the payment means of the star, the payment means preferably includes the check card, the online payment, the coupon or the like for transferring a payment limit amount. When using the check card as the payment means, the financial server 12 may be a bank.

In addition, the star-following product sale server 20 further provides an electronic payment means such as Star Pay to the star exclusive product purchase application 4 so as to use payment limit amounts assigned for each star in purchasing the products, and performs the payment by communication therebetween.

When using the credit card as the payment means, it is necessary to synchronize payment limit data with the financial server 12 which is a credit card company, so that the payment limit assigned by the star-following product sale server 20 may be applied in real time.

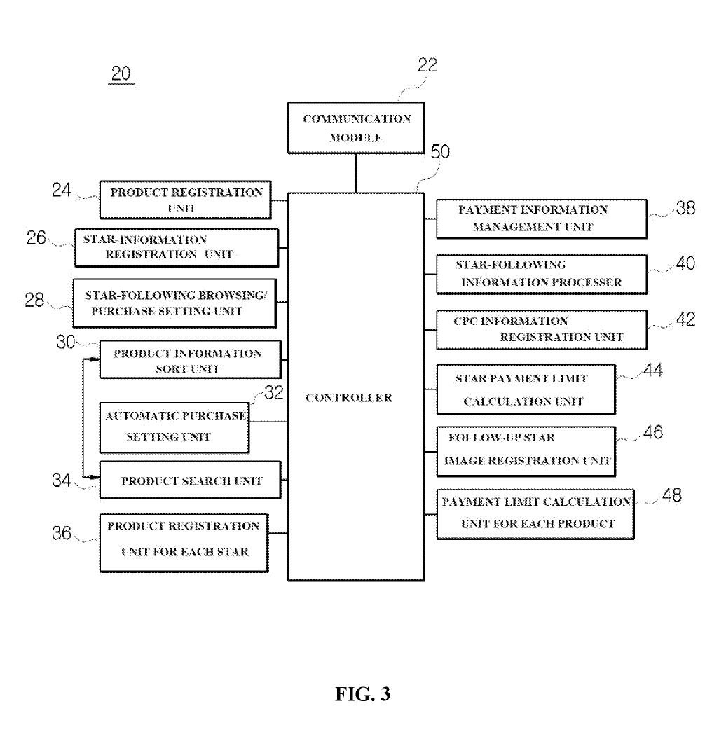

FIG. 3 is a block diagram illustrating a configuration of the star-following product sale server included in the star-following product sale system according to the embodiment of the present invention.

Referring to FIG. 3, the star-following product sale server 20 included in the star-following product sale system according to the embodiment of the present invention further includes: a communication module 22 configured to communicate with the applications and the servers; a product registration unit 24 configured to register information of products to be sold; a product registration unit 36 for each star configured to classify and register the information of the products to be sold as a sub-category of a specific star so that the specific star can browse or purchase the products to be sold; a star information registration unit 26 configured to register information of a star who can purchase the products registered in the product registration unit 24 and desires to receive a payment limit amount provided upon purchase of the product; and a controller 50 configured to control the registration units so as to provide a part of the profits generated based on the browsing of information on star-following products for each specific star or star-following purchase as payment limit amounts for each product of the specific star, thereby inducing the star-following browsing or purchase of the products.

That is, the star registers his/her own information through the star information registration unit 26 included in the star-following product sale server 20, and the seller registers information of the products to be sold in the product registration unit 24. At this time, the product information to be registered in the product registering unit 24 may be information of a general product that does not want to designate a specific star, and information of a product to be exposed to all the stars or information of a product to be exposed only when the star tries to separately browse the product.

When registering the product information by the seller, the product registration unit 36 for each star allows the seller to register the product information by designating a specific star. In this case, the product information is exposed only to the designated star.

Meanwhile, when purchasing a product by following the star, the star-following product sale system according to the embodiment of the present invention allows the user to purchase the product by any one of automatic purchase and manual purchase.

The manual purchase means that the star-following user browses the product information and then performs star-following purchase by free intention thereof, and the automatic purchase means that the star-following user automatically purchases a product which is purchased by a specific star designated by the user.

To this end, the star-following product sale server 20 includes: an automatic purchase setting unit 32 configured to set automatic purchase of information on a specific product purchased by the specific star; and a product search unit 34 configured to search for the specific product among the products registered in the sale server.

In order to register an advertisement cost per click (CPC) for each seller and each product when browsing information of the product transmitted to the star-following user, the star-following product sale server 20 further includes an advertisement cost per click (CPC) information registration unit 42 configured to register information of an advertisement cost per click provided upon browsing the product information.

In addition, the star-following product sale server 20 further includes a star-following browsing/purchase setting unit 28 configured to register information of the star-following user including designation information on a specific star desired to follow, desired category information on a star-following product, and desired amount range information on the star-following product.

For browsing of the product information or the star-following purchase of the product, the star-following user may further define and set a category of the specific product and an amount range of the product, not by limiting and setting only a condition of the product purchased by the specific star.

For example, a specific star-following user may not be interested in purchasing a product as well as in browsing information for a category or amount beyond a certain range according to taste, age, and economic power thereof. Therefore, it is possible to limit the product information to be received by each individual user, and limit the product to be automatically purchased.

In addition, when a plurality of sellers register the product information so as to be matched to the star in order to execute a star-following sale and marketing for the specific star, the star-following product sale server 20 needs to assign a sort order to each product so that the star can browse a plurality of registered products in a certain order.

Accordingly, the star-following product sale server 20 further includes a product information sort unit 30 configured to sort the registered products according to a specific sort condition selected by the star. The specific sort condition may be sequential orders of a concept or a category to which the product pertains, a promotion amount of the product, a promotion rate for a sale price of the product and the like.

In other words, the star may select any one from a variety of re-sorted items. When selecting a concept such as a specific concept, for example, ‘party,’ product information having a keyword ‘party’ is extracted and sorted, and even if selecting a specific category, the product information is sorted through the same extraction. After the product is firstly selected as a concept or a category, or otherwise, even if the product is not firstly selected, it is preferable that the sort order is a sequential order of a star promotion amount or ratio for the product.

At this time, if the amount of the star promotion is large, an amount provided to the star in a case of purchasing one corresponding product is larger than that of a case of purchasing another product. As a result, the product information is sorted in descending order from the highest payment limit.

Meanwhile, the star-following product sale server 20 further includes a star payment limit calculation unit 44 configured to calculate the payment limit of the star based on the profit generated due to the star. The star payment limit calculation unit 44 calculates the payment limit so that an amount, which is obtained by multiplying an advertisement cost per click (CPC) for each product with being classified into each star by the number of users set to perform star-following browsing, is included in the payment limit amount for each product of the star upon calculation.

In addition, the star payment limit calculation unit 44 may calculate the payment limit so that an amount, which is obtained by multiplying a star sale promotion amount classified into each star and assigned for each product by the number of users set to perform an automatic star-following purchase, is included in the payment limit amount for each product of the star upon calculation.

In addition, the star payment limit calculation unit 44 may calculate the payment limit so that an amount, which is obtained by multiplying an estimated sale rate for each star based on a purchase rate among the total number of browsing users by the number of users set to perform star-following browsing, is included in the payment limit amount for each product of the star upon calculation.

Meanwhile, when the star-following user tries to perform the star-following browsing or star-following purchase by driving the star-following purchase application 8 provided in the star-following user terminal 6, and the user purchases the product, then the star-following product sale server 20 transmits electronic payment means information including an image of a star predesignated by the star-following user to the star-following user terminal 6.

Accordingly, in a case of a star-following user having a plurality of designated and set stars, it is possible to determine that the purchased product is a star-following purchase product of what star by checking the image of the star output on a screen by the star-following purchase application 8.

For example, assuming that the electronic payment means included in the star-following purchase application 8 is ‘star pay,’ if a star purchasing a product is Song Hye-kyo, a famous Korean actress, and Song Hye-kyo is set as a star designated by the star-following user, an image of Song Hye-kyo is output on the screen by the star-following purchase application 8. Therefore, it is possible to exhibit a high level of fan-loyalty as if making a payment with differentiated pay called “Song Hye-kyo pay.”

More preferably, the star-following product sale server 20 further includes a follow-up star image registration unit 46 configured to register an image of a star predesignated by the star-following user so as to transmit product information to the star-following user terminal 6 at the time of browsing the product information or purchasing the product through the star-following user terminal 6.

In addition, the star-following product sale server 20 further includes: a payment information management unit 38 configured to manage payment information of the star and star-following user; and a star-following information processer 40 configured to extract information of a star-following user who designates a star when purchasing a product by the star, and transmit information of the product purchased by the star or perform automatic purchase of the product.

Meanwhile, as described above, a star-following user capable of generating a purchasing power may designate a specific star and a specific category of products and/or an amount range of the products. Therefore, star-following users who designate the same star as each other may or may not correspond to a case of performing the star-following browsing of the product information or star-following purchase of the product.

As a result, payment limits for each star are different for each product.

For this end, the star-following product sale server 20 further includes a payment limit calculation unit 48 for each product configured to, when clicking a plurality of pieces of product information registered to be purchased by the specific star, manage a payment limit for each product, which is calculated based on the number of the star-following users for the star, a category, an amount range and a promotion rate of the products, so as to be transmitted by a request of the star.

Thereby, when the star selects a plurality of products to be exposed to him or her, the star-following product sale server 20 calculates the payment limit by reflecting the star-following user corresponding to the product through the payment limit calculation unit 48 for each product, and provides the calculated payment limit to the star terminal 2.

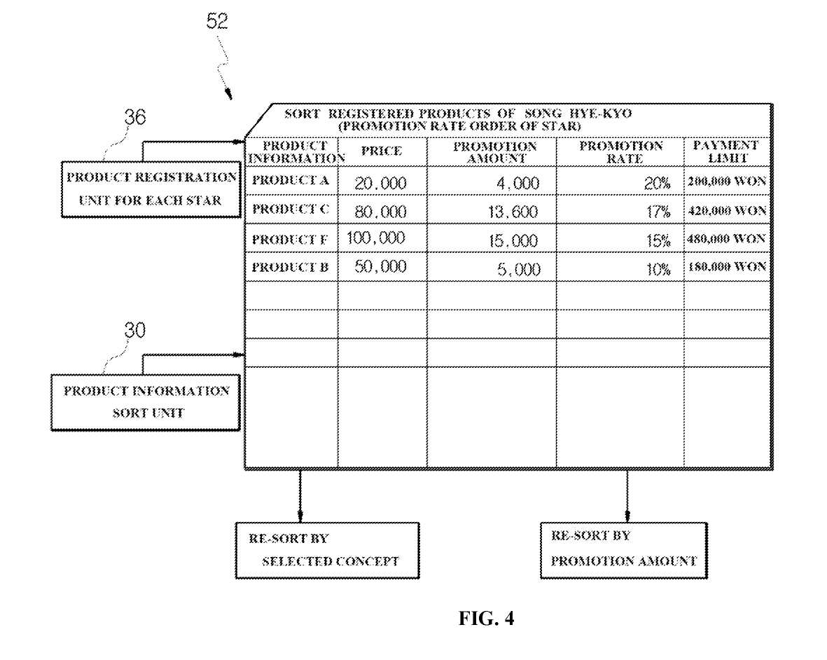

FIG. 4 is a diagram illustrating product sort information output to the star through the star-following product sale system according to the embodiment of the present invention.

Referring to FIG. 4, in the star-following product sale system according to the embodiment of the present invention, when a plurality of sellers try to spread follow-up marketing by matching a plurality of products to a star, the star-following product sale server 20 needs to assign a sort order to the respective products so that the star can browse the plurality of registered products in a certain order.

Accordingly, the star-following product sale server 20 further includes a product information sort unit 30 configured to sort the registered products according to a specific sort condition selected by the star. The specific sort condition may be sequential orders of a concept or a category to which the product pertains, a promotion amount of the product, a promotion rate for a sale price of the product and the like.

The sort condition item may be selected by the star.

For example, in FIG. 4, when a star selects a promotion rate of the star as the sort item, a plurality of products are resorted in descending order from the highest promotion rate.

In addition, when a star selects a promotion amount as the sort item, promotion amounts, which are a factor to increase the payment limit of the star when selling the product, are sorted in descending order from the highest promotion amount.

In addition, in a case of selecting a specific concept by the star to reorder the products, when selecting a concept such as a specific concept, for example, ‘party,’ product information having a keyword ‘party’ is extracted and sorted, and even if selecting a specific category, the product information is sorted through the same extraction. Even if the product is firstly selected as a concept or a category, or otherwise, even if the product is not firstly selected, it is preferable that the sort order is a sequential order of a star promotion amount or ratio for the product.

At this time, if the amount of the star promotion is large, an amount provided to the star in a case of purchasing one corresponding product is larger than that of a case of purchasing another product. As a result, the product information is sorted in descending order from the highest payment limit.

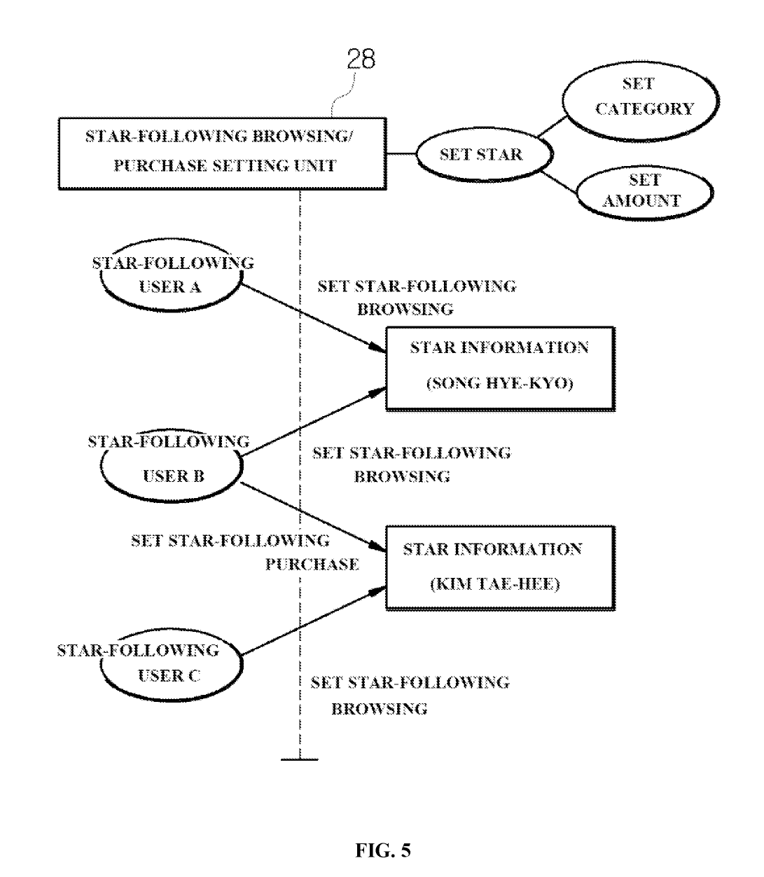

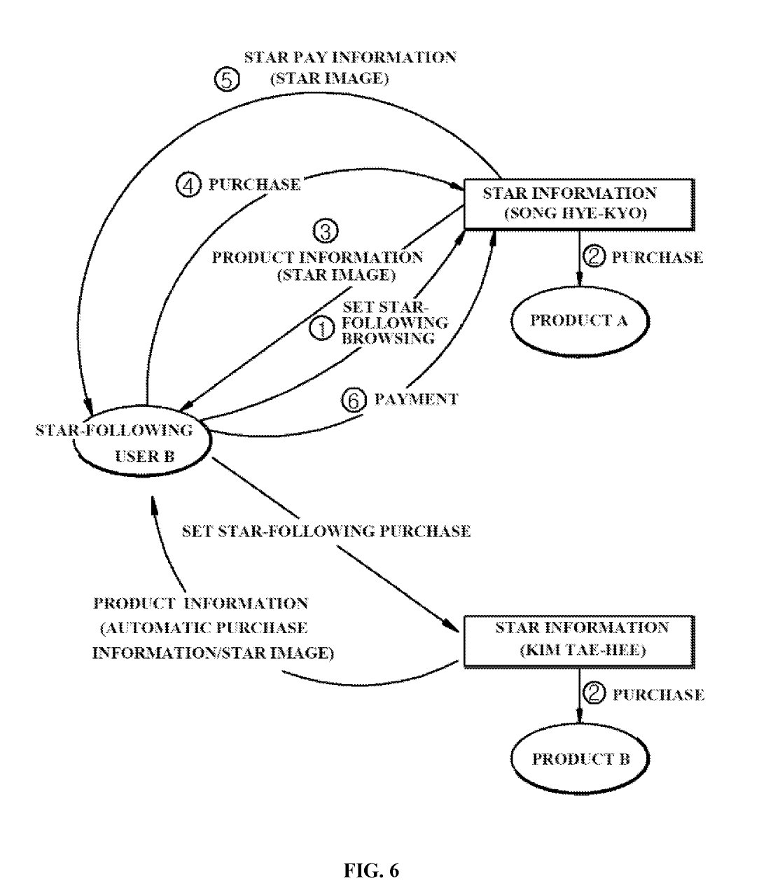

FIG. 5 is a diagram for explaining setting and information transmission principles for the star-following browsing and star-following purchase through the star-following product sale system according to the embodiment of the present invention, and FIG. 6 is a diagram illustrating a state of setting to follow a plurality of stars through the star-following product sale system according to the embodiment of the present invention.

Referring to FIGS. 5 and 6, the star-following product sale system according to the embodiment of the present invention allows the star-following user to set a specific star or a plurality of specific stars, and receive information on the product purchased by the star. Herein, automatic purchase for the product purchased by the star may be preset.

In this case, since the star-following user designates his or her favorite star and browses or purchases the product purchased by the star, browsing of the product information also has a considerably large advertising effect.

In addition, the star-following user who sets the automatic purchase may be a fan whose familiarity to the star is much larger than other fans, or a person having an experienced eye on the selection of the star's products, which is matched with his/her tastes.

Meanwhile, the star-following user may set star-following browsing for a star to browse information of the product purchased by the star, and may also set star-following purchase for another star so as to perform the automatic purchase of the product purchased by the star.

Also, when applying the star-following product sale system according to the embodiment of the present invention to an offline affiliate, it is necessary to have the same structure as that of an online affiliate, or provide information of the affiliates that sell products or provide services to be purchased by the star to the star-following product sale server 20.

However, when specific products are paid by many affiliates, detailed product information is not provided to the star-following product sale server 20, such that only the corresponding affiliate information may be provided to the star-following user.

For example, when a star makes a payment at a specific offline affiliate with the star pay added to the star exclusive product purchase application 4, the star-following product sale server 20 may receive the payment information to be confirmed by the star. The payment information is limited information to a degree of indicating a payment amount paid to a certain product at 00 affiliate rather than detailed product information.

In addition, the affiliate information capable of being recognized by the star-following product sale server 20 may include information on a large category of the food and beverage industry, for example.

Therefore, the star-following product sale server 20 transmits the affiliate information and price information to the star-following users who set the star-following purchase or star-following browsing for the star. When the users visit the affiliate and make payments using the star pay added to the star-following purchase application 8, the affiliate and the star-following product sale server 20 may confirm whether it is a star-following purchase or not.

At this time, the star pay is a payment means allows the affiliate and the star-following product sale server 20 to simultaneously authenticate the payment of the star at the offline affiliate, the star-following browsing and the star-following purchase executed by the star-following user.

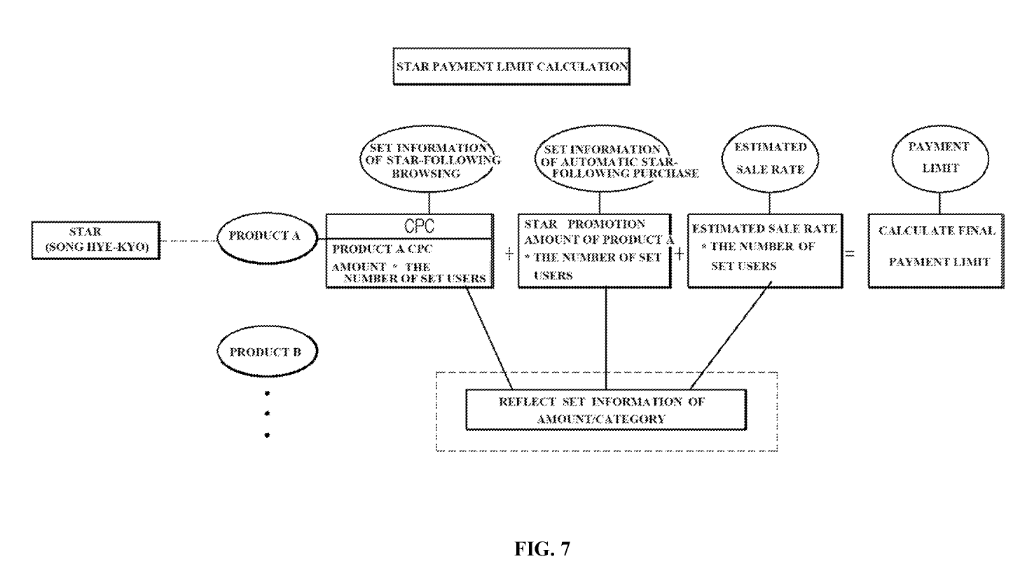

FIG. 7 is a block diagram illustrating a state of calculating a payment limit of the star through the star-following product sale system according to the embodiment of the present invention.

Referring to FIG. 7, in the star-following product sale system according to the embodiment of the present invention, the payment limits of the star are assigned differently for each product selected by each star.

That is, if different star-following users having the same designation of a specific star set different categories from each other due to various tastes, and the star wants to limitedly receive the product information only when the star purchases the product corresponding to the category, the number of the star-following users who want to receive the product information for each category is changed.

Therefore, assuming that the advertisement costs per click (CPC) are the same as each other for each product, total advertising profits different from each other are generated for each category.

In addition, if the promotion costs provided to the star are different from each product for the star-following users at the time of the sale of the product, then the payment limits are differently calculated for each product.

In addition, final payment limits, in which the estimated sale rate is reflected based on the number of users of the automatic purchase preset in the star-following product sale server 20 and cumulative data, are different from each product.

As a result, the star-following product sale system according to the embodiment of the present invention has a structure in which the profit generated from the star-following users who perform the star-following browsing or star-following purchase of the product information based on purchase of the products for each star is replaced with the payment limit.

For example, in a case of purchase, assuming that the number of star-following users who register the automatic purchase to follow Star A or information reception is 10, and when the number of star-following users who perform the star-following purchase is 7, the sale rate is 70%. At this time, if a margin of the product is 20% and the promotion rate is set to be 5%, the payment limit is 500 won when purchasing a product of 10,000 won by the star.

If 100 users execute the star-following purchase under the same condition as described above, the payment limit of the star is 5,000 won. Therefore, when the number of star-following users expected to perform the star-following purchases is 200, the payment limit of the star may be 10,000 won, thus to purchase the product without cost.

In addition, if 2,000 users execute the star-following purchase under the same condition as described above, the payment limit of the star is 100,000 won. When the number of star-following users to perform the star-following purchases is 20,000, the payment limit of the star is 1 million won.

In this case, the advertisement cost per click (CPC) is not considered.

Therefore, in the final payment limit through the star-following product sale system according to the embodiment of the present invention, an amount, which is obtained by multiplying the advertisement cost per click (CPC) for each product generated during star-following browsing the information of the product purchased by the star by the number of users set to perform star-following browsing, is included in the payment limit amount for each product of the star upon calculation.

At this time, the number of users set to perform star-following browsing refers to the number of users who designate a specific star and purchase the product of the star within the desired specific category, when the product purchased by the star corresponds to a group of amounts preset by the star-following user.

For example, when the number of users who designate a specific star is 100,000 and the number of users who select a home appliance category is 50,000 among the 100,000 star-following users, if the star purchases an audio system, the number of star-following users is reduced to 50,000. At this time, if the number of users set to limitedly receive the product information only when the star purchases the product corresponding to the amount range of the product of 500,000 won or less among the 50,000 star-following users, and perform star-following browsing of the product information, the total number of users set to perform the star-following browsing is 30,000.

Further, assuming that the advertisement cost per click of the product purchased by the star is 50 won, in the star-following product sale server 20, a payment limit amount that can be obtained with the advertisement cost per click (CPC) is 150,000 won obtained by multiplying 50 won by 30,000.

Furthermore, similar to the above case, when the number of the star-following users who select the automatic purchase for the corresponding star, and are set to perform the automatic purchase when the star purchases the product corresponding to the category and the amount range of the product purchased by the star, is 30, and if a star promotion cost of 10,000 won is generated per one product, an amount that can be obtained by the automatic purchase of the star-following user is 300,000 won.

Meanwhile, when the number of the star-following users who select the manual purchase to browse the product information and manually determine the purchase for the corresponding star, and receive the product information when the star purchases the product corresponding to the category and the amount range of the product purchased by the star is 30,000, and the estimated sale rate of the star is 5%, the number of star-following users expected to select the manual purchase is 1,500.

In this case, since a star promotion cost of 10,000 won per product is generated, when sales of 1500 products are expected, the payment limit may be increased by 15 million won.

Accordingly, the final payment limit calculated by the star-following product sale server 20 which may be caused by the purchase of the star is 16.8 million won which is a sum of 1.5 million won, 300,000 won and 15 million won.

Thereby, it can be seen that the CPC is the same as the number of users set to perform the manual star-following purchase, but is different from the number of users set to perform the automatic star-following purchase.

In the case of star-following browsing or star-following purchase, regardless of popularity, star-following purchase members may be formed by a star who has a quasi-professional eye for product selection. In other words, for a specific product, a B-list star may have larger star-following purchase members than an A-list star. The payment limit of the star is changed in real time by star-following purchase. However, when paying a price of the product purchased by the star, the payment limit amount is further changed by subtracting the purchase price.

As a result, when browsing product information or purchasing and making a payment of the product by a user who follows the star to perform star-following browsing or a star-following purchase through the system, the payment limit of the star may be increased and a limit of an amount on the selection of the star may be removed by the above star-following browsing or star-following purchase action. Therefore, it is possible to give more freedom to the star in the selection of products, and provide useful product information to star-following purchasers, such that a cycle of star-driven positive reinforcement can be formed therebetween.

Meanwhile, the star-following product sale system and method according to the embodiment of the present invention are not limited to the above exemplary embodiment but may be variously changed without departing from the technical subjects thereof.

### DESCRIPTION OF REFERENCE NUMERALS

2: Star terminal

4: Star exclusive product purchase application

6: Star-following user terminal

8: Star-following purchase application

10: Sale server

12: Financial server

1. A star-following product sale system comprising:
a star terminal 2 provided with a star exclusive product purchase application 4 configured to receive product information and payment limit information for each product from a star-following product sale server 20;
a star-following user terminal 6 provided with a star-following purchase application 8 configured to set a specific star who is a target of star-following browsing or star-following purchase in the star-following product sale server 20, receive and browse information of a product purchased by the specific star from the star-following product sale server 20, and generate a purchase signal for the product;
a sale server 10 configured to register the product information and star designation information in the star-following product sale server 20; and
the star-following product sale server 20 configured to register the product information for each star designated by a seller so as to purchase the product by the star, register information of a user who desires to perform the star-following browsing or star-following purchase of each star, calculate payment limits of each star to provide to the stars, and update the payment limits based on profits generated for a star-following user due to the purchase of the stars.

2. The star-following product sale system according to claim 1, wherein the star-following product sale server 20 comprises an automatic purchase setting unit 32 configured to set automatic purchase of information on a specific product purchased by the specific star; and
a product search unit 34 configured to search for the specific product among the products registered in the sale server.

3. The star-following product sale system according to claim 1, wherein the star-following product sale server 20 further comprises an advertisement cost per click (CPC) information registration unit 42 configured to register information of an advertisement cost per click provided upon browsing the product information.

4. The star-following product sale system according to claim 1, wherein the star-following product sale server 20 further comprises a star-following browsing/purchase setting unit 28 configured to register information of the star-following user including designation information on a specific star desired to follow, desired category information on a star-following product, and desired amount range information on the star-following product.

5. (canceled)

6. The star-following product sale system according to claim 1, further comprising a financial server 12 configured to assign accounts for each star in conjunction with the star-following product sale server 20, and make a payment for the product by an amount transferred or payment limit assigned to the accounts from the star-following product sale server 20.

7. (canceled)

8. The star-following product sale system according to claim 1, wherein the star-following product sale server 20 further comprises a star payment limit calculation unit 44 configured to calculate a payment limit of the star so that an amount, which is obtained by multiplying an advertisement cost per click (CPC) for each product with being classified into each star by the number of users set to perform star-following browsing, is included in the payment limit amount for each product of the star upon calculation.

9. The star-following product sale system according to claim 1, wherein the star-following product sale server 20 further comprises a star payment limit calculation unit 44 configured to calculate a payment limit so that an amount, which is obtained by multiplying a star sale promotion amount classified into each star and assigned for each product by the number of users set to perform an automatic star-following purchase, is included in the payment limit amount for each product of the star upon calculation.

10. The star-following product sale system according to claim 1, wherein the star-following product sale server 20 further comprises a star payment limit calculation unit 44 configured to calculate a payment limit so that an amount, which is obtained by multiplying an estimated sale rate for each star based on a purchase rate among the total number of browsing users by the number of users set to perform star-following browsing, is included in the payment limit amount for each product of the star upon calculation.

11. (canceled)

12. The star-following product sale system according to claim 1, wherein the star-following product sale server 20 further comprises:
a communication module 22 configured to communicate with the applications and the servers;
a product registration unit 24 configured to register information of products to be sold;
a product registration unit 36 for each star configured to classify and register the information of the products to be sold as a sub-category of a specific star so that the specific star can browse or purchase the products to be sold;
a star information registration unit 26 configured to register information of a star who purchases the products registered in the product registration unit 24 and desires to receive a payment limit amount provided upon purchase of the product; and
a controller 50 configured to control the registration units so as to provide a part of the profits generated based on the browsing of information on star-following products for each specific star or star-following purchase as payment limit amounts for each product of the specific star, thereby inducing the star-following browsing or purchase of the products.

13. The star-following product sale system according to claim 1, wherein the star-following product sale server 20 further comprises:
a payment information management unit 38 configured to manage payment information of the star and star-following user; and
a star-following information processer 40 configured to extract information of a star-following user who designates a star when purchasing a product by the star, and transmit information of the product purchased by the star or perform automatic purchase of the product.

14. The star-following product sale system according to claim 1, wherein the star-following product sale server 20 further comprises a payment limit calculation unit 48 for each product configured to, when clicking a plurality of pieces of product information registered to be purchased by the specific star, manage a payment limit for each product, which is calculated based on the number of the star-following users for the star, a category, an amount range and a promotion rate of the products, so as to be transmitted by a request of the star.

15-16. (canceled)

17. A star-following product sale method comprising:
a) receiving, by a star-following product sale server 20, a selection signal for a specific product from the star terminal 2;
b) transmitting, by the star-following product sale server 20, payment limit amount information for the specific product of a star;
c) receiving, by the star-following product sale server 20, a purchase signal for the specific product from the star terminal 2;
d) making, by the star-following product sale server 20, a payment of a product purchased by the star;
e) transmitting, by the star-following product sale server 20, information of the product to a user who preregisters star-following browsing of the product purchased by the star;
f) receiving, by the star-following product sale server 20, a purchase signal for the product from a star-following user terminal 6;
g) calculating, by the star-following product sale server 20, a payment limit amount for the product of the star; and
h) updating, by the star-following product sale server 20, the payment limit amount for the product of the star.

18. The star-following product sale method according to claim 17, further comprising: before the step a),
receiving and registering, by the star-following product sale server 20, designation information of a specific star and product information, and amount information from a seller, and amount information to be promoted to the star for the product at the time of purchasing the product by a star-following user.

19. The star-following product sale method according to claim 17, further comprising: before the step a),
receiving and registering, by the star-following product sale server 20, set information of a specific star who is a target of star-following browsing or star-following purchase from the star-following user terminal 6.

20. The star-following product sale method according to claim 17, further comprising: before the step a),
extracting, by the star-following product sale server 20, information of the product matched to the star, and transmitting the extracted product information to the star terminal 2.

21. The star-following product sale method according to claim 17, further comprising: before the step a),
receiving and registering, by the star-following product sale server 20, information of a star-following user including designation information on a specific star desired to follow, desired category information on a star-following product, and desired amount range information on the star-following product from the star-following user terminal 6.

22. The star-following product sale method according to claim 17, further comprising: before the step a),
transmitting, by the star-following product sale server 20, information of products predesignated by a star-following user to the star terminal 2.

23. (canceled)

24. The star-following product sale method according to claim 17, wherein the step g) comprises calculating, by the star-following product sale server 20, a payment limit of the star so that an amount, which is obtained by multiplying an advertisement cost per click (CPC) for each product with being classified into each star by the number of users set to perform star-following browsing, is included in the payment limit amount for each product of the star upon calculation.

25. The star-following product sale method according to claim 17, wherein the step g) comprises calculating, by the star-following product sale server 20, a payment limit so that an amount, which is obtained by multiplying a star sale promotion amount classified into each star and assigned for each product by the number of users set to perform an automatic star-following purchase, is included in the payment limit amount for each product of the star upon calculation.

26. The star-following product sale method according to claim 17, wherein the step g) comprises calculating, by the star-following product sale server 20, a payment limit so that an amount, which is obtained by multiplying an estimated sale rate for each star based on a purchase rate among the total number of browsing users by the number of users set to perform star-following browsing, is included in the payment limit amount for each product of the star upon calculation.

27-30. (canceled)
